(19) United States
(12) Patent Application Publication
(10) Pub. No.: US 2018/0139996 A1
(43) Pub. Date: May 24, 2018

(54) SPHERICAL FLAVORING PARTICLES FOR ENHANCING TASTE TO A DRINK

(71) Applicant: NASSER A. IKHLAIL, EL PASO, TX (US)

(72) Inventor: NASSER A. IKHLAIL, EL PASO, TX (US)

(21) Appl. No.: 15/360,987

(22) Filed: Nov. 23, 2016

(51) Int. Cl. A23L 27/00; A23L 2/56

(52) U.S. Cl. CPC A23L 27/88; A23V 2002/00; A23L 2/56

(57) ABSTRACT

The invention concerns particles for use in delivering a distinct and enhanced taste sensation to a drink, wherein the particles are adapted for dissolving in a drink, and wherein said particles comprise at least one flavor component incorporated therein. The invention further concerns a drink comprising these particles and a method for its preparation.

### BACKGROUND OF THE INVENTION

### 1. Field of the Invention

The present invention relates to particles for use in enhancing taste of drinks with significant improvements in regards to preparation accuracy, effort, time, and preservation flavor integrity.

### 2. Description of the Prior Art

The addition of flavor components to a drink can be achieved in many ways and at different stages. Flavor components may be originally and independently added to a base drink or may be further added to an already flavored drink to enhance its original flavor composition. Flavor components may be added in powder or liquid form (i.e. a concentrated syrup or extract) to a virgin base drink or to an already flavored composite drink.

In the current state of the art, several different mediums exist for adding flavor to a water based drink. The utilization of capsules and tablets for flavoring food products is of no novelty and has been widely recognized in the state of the art. Flavoring impact is achieved through the use of essential oils, combinations of alcohols, proteins, carbohydrates, among other ingredients, of natural or synthetic precedence; in aqueous or powder form.

Nevertheless, in the current state of the art, small particle sizes of capsule/tablets are the predominant medium for the encapsulation of flavoring agents. Utilizing a small particle size for flavoring purposes poses a significant challenge for the end consumer in regards to ease of preparation.

As flavoring agents are delivered in small particle sizes, ease of use and practicality is significantly sacrificed when determining the right amount of particles to include in order to achieve a desired flavoring result. The utilization of small particles further requires the use of additional tools for administrating the necessary amounts to accomplish the desired flavoring effect; thus, adding another level of complexity to the flavoring process. Finally, the majority of these mediums make use of dissolution agents to achieve desired dissolution times, resulting in compromised flavor integrity due to the negative impact of such agents.

In U.S. Pat. No. 4,634,598 (Liu, et al.), flavored capsules having a particle size of 2.5 mm to 3.5 mm containing aromatic and/or flavor principles of food materials are disclosed. Although similar in functionality to the present invention, it is important to identify “particle size” as the main differentiator when compared to the current invention. Same differentiation point applies to: U.S. Pat. No. 8,617,628 (Siegel, et al.), Spherical Core-shell-particle; 20150104552 (Crawford, et al.), Capsule Clusters for Oral Consumption.

An essential composition characteristic of the present invention is its lack of dissolution agents. This absence results in a flavor-integrity preservation-dimension that further adds to its very own utility. The use of these agents becomes evidently apparent in several registered patents that belong to this area of invention. In U.S. Pat. No. 7,425,341, (Grimshaw, et al.) a Rapidly Disintegrable Tablet is described which incorporates a beneficial ingredient, ondansentron, in order to promote tablet dissolution. Grimshaw further includes other possible disintegrants: microcrystalline cellulose, sodium carboxymethyl cellulose, calcium carboxymethyl cellulose, modified cellulose gum, crospovidone, alginic acid and alginates, pregelatinized starch, among others. It is the exclusion of these and other disintegrating agents that allow the current invention to present improvements in preserving flavor integrity, which ultimately translate into a higher quality flavoring process. To further alienate U.S. Pat. No. 7,425,341 from the current invention, it becomes evident that a preferred purpose of the application is not related to the flavoring process of a water-based drink, but more of an orally disintegrating tablet that dissolves rapidly when contacted with saliva.

In addition to dissolution agents, the incorporation of gases for improving tablet dissolution has also been a popular concept in the current state of the art. In U.S. Pat. No. 6,953,592, Water Soluble Powders and Tablets, Darbyshire et al., describe tablet dissolution improvements by means of incorporating specific gases such as Nitrogen and Oxygen within the tablet. By subjecting tablets to a gas loading treatment within a controlled environment, desired porosity levels are created in order to obtain tablet dispersion improvements.

As previously mentioned, the incorporation of dissolution agents is highly popular in the current state of the art, the inclusion of which has negative repercussions in the taste impact of the resulting flavored drink. The current invention's lack of dissolution agents or other dissolution ingredients completely eliminates this detrimental impact, as dissolution of the flavoring particle solely depends on the inherent characteristics of its very own composition and the strategically formulated porosity levels between its components.

In regards to shape, significant contrast exists when comparing this invention to the state of the art: In U.S. Pat. No. 6,953,592 (Darbyshire, et al.), Water Soluble Powders and Tablets, semi-cylindrical tablets with diameter of 38 mm and height of 2 mm are cited. Creating a significant differentiation point from the current invention based on size and shape of particle. Same differentiation point applies to: U.S. Pat. No. 6,277,428 (Franklin, et al.), Beverage Beans and Methods for their Manufacture and Use; 20100104695 (Faella; Nancy Z.; et al.), Instant Beverage Cubes; U.S. Pat. No. 7,425,341 (Grimshaw, et al.), Rapidly Disintegrable Tablets.

It would be desirable to have a medium for adding a flavor component to a drink, in which such component would not present a negative impact on the taste sensation of the drink itself. In addition, more desired is the possibility to achieve a mouth taste sensation, which is composed of the basic taste of a liquid drink, the particles having a distinct taste and fast dissolving in a drink. Due to its most preferred structural shape, size, and composition, the current invention solves the aforementioned problematic, as it provides with a more practical, accurate, and efficient medium for achieving a flavoring process, with minimal amount of effort and time.

### SUMMARY OF THE INVENTION

The current invention represents a flavoring particle that provides an enhanced and distinct taste sensation to a drink, specifically relating to a spherically shaped, fast dissolving particle, utilized for infusing flavor to a drink. The particle is composed of a flavoring agent as well as a sweetening agent. The flavoring agent represents an ingredient of natural, synthetic, and/or artificial origin, whose main purpose it to provide water based drinks with a taste effect, detectable by the human sense when orally ingested. The sweetening agent represents an element from the family of polysaccharides, whose origin could be derived from a natural, synthetic, and/or artificial process for producing sweetening ingredients. Both agents, flavoring and sweetener, are considered edible, nontoxic, food substances that are soluble in water. Consumption of the flavored infused drink results in an enhanced taste sensation upon dissolution the particles. measurements and use of pouring tools (spoons, serving cups) for administrating the flavoring agents, thus significantly facilitating the flavoring process from a practicality perspective.

In one preferred embodiment, the particle has one or more air pockets incorporated within its core structure for effecting fast dissolution within the drink.

The present invention has no intention of establishing any utility merits in such area, as its main utility focus consists of enhancing the flavoring process and effect of a liquid aqueous substance, defined herein as a drink, by providing ease of preparation and a higher flavor impact, accomplished through the preservation of flavor integrity and a lack of disintegrating agents.

Further objects and advantages of the present invention will become apparent by reference to the following detailed disclosures of the invention and appended drawings wherein like reference numerals refer to the same feature, component, or element.

### DETAILED DESCRIPTION OF THE INVENTION

The spherical particle is composed of a flavoring agent as well as sweetening agent. The flavoring agent may come in different physical states; most preferably in powder form. Its origin may be derived from a natural or synthetic process, most preferably from a freeze drying process of natural raw fruit.

The sweetening agent belongs to any type of polysaccharides, in various physical states; most preferably in powder form. The caloric content of which could be of a high, low, average, or zero calorie sweetener, most preferably about 0-5 calories per gram.

The current invention's porosity levels are strategically determined by result of a compression process of the stated components through the use of iron molds. Porosity levels are achieved based on a delicate balance between the proportions of the invention's constituents and the amount of force exerted through the molding process. The porosity attribute of the present invention is defined as a measurement of the spaces between each of the spherical particle components.

The spherical shape of the particle is constructed by a powdering compression process through the use of iron molds and a standard press machine. Such volume compression process is achieved by exerting a compression force, which results in the invention's size being approximately 0-8 centimeters in diameter, more preferably from about 1.5 to 6.5 centimeters, most preferably from about 2.5 to 4 centimeters.

The spherical shape has an outer surface area most preferably in the range of 15 to 50 squared centimeters. Mass is preferably in the range of 15 to 30 grams, particularly preferred from 20 to 30 gr. It is important to consider that the shape and size attributes of the present invention play an essential role in providing it with its current improved utility, as well as uniquely differentiates and novelizes it from the current state of the art:

The following examples further illustrate the preferred embodiment of the present invention. These examples should not be considered for limiting the inventions scope but instead for better appreciation of the invention.

### Example 1

A premix of strawberry freeze-dried fruit powder and cane sugar is made in ratio of the total weights of components of 1:1.3, respectively, with total mass of 26 gr. Ingredients are uniformly mixed for further press compression by use of iron molds

### Example 2

The premix described in example 1 is poured into iron molds and compressed through a standard shop press machine. Magnesium Sterate is utilized as lubricant and lightly applied to the mold's surface walls. This allows for easy separation of the compressed spherical particle from the mold's walls. The end result becomes a spherically shaped particle of 3.81 cm in diameter.

### Example 3

A spherically compressed particle, described in example 2, is dropped into 16 oz of water. After being submerged for 20 seconds, the particle completely dissolves. Additional, minimal, manual stirring is required to achieve complete dissolution of the particle. The end result is an enhanced flavored drink requiring minimal amount of preparation time and effort.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

1. A particle for use in delivering a distinct and enhanced taste sensation to a drink, wherein the particle is composed of a core made of edible material, adapted for fast dissolving in said drink, and wherein said particle comprises a mixing comprising at least one flavor component.

2. (canceled)

3. The particle according to claim 1, wherein said core comprises at least one substance selected from the array of calorie sweeteners consisting of polysaccharides, natural, synthetic, and artificial origin.

4. The particle according to claim 3, wherein said caloric sweetener is selected from the group consisting of high, low, and zero calorie content sweeteners.

5. The particle according to claim 1, wherein said flavor component is embedded, impregnated, or incorporated in the particle.

6. The particle according to claim 1, wherein said flavor component is in a form adapted for dissolving in a drink.

7. The particle according to claim 1, wherein said flavor component comprises at least one flavor component selected from the flavor group consisting of natural, synthetic, and artificial flavor agents.

8. The particle according to claim 1 is essentially spherical shape, wherein said spherical shape has a size of approximately 2-8 centimeters in diameter.

9. (canceled)

10. The particle according to claim 1, further comprising an outer layer.

11. The particle according to claim 10, wherein said outer layer consists of a seamless, highly porous, smooth surface.

12. (canceled)
